(19) United States
(12) Patent Application Publication
(10) Pub. No.: US 2010/0153009 A1
(43) Pub. Date: Jun. 17, 2010

(54) METHOD AND SYSTEM FOR CREATING TOURIST PATHS ADAPTED TO BE USED BY PORTABLE NAVIGATION SYSTEM

(75) Inventor: GIORGIO PELOSIO, Cagliari (IT)

Correspondence Address: DYKAS, SHAVER & NIPPER, LLP, P.O. BOX 877, BOISE, ID, 83701-0877, US

(73) Assignee: EUPORICERCHE S.R.L., Elmas, Cagliari (IT)

(21) Appl. No.: 12/599,829

(22) PCT Filed: May 14, 2008
(86) PCT No.: PCT/IB08/01200

§ 371 Date: Jan. 21, 2010

(30) Foreign Application Priority Data
May 16, 2007 (IT) TO2007A000343

(51) Int. Cl. G01C 21/36; G06Q 30/00; G06F 17/30; G06F 3/048

(52) U.S. Cl. 701/209; 705/27; 701/206; 707/812; 715/771; 707/E17.009

(57) ABSTRACT

The invention relates to a method and a system for creating tourist paths adapted to be used by a portable navigation device, said method comprising the steps of: a) entering characteristic parameters of a structure capable of offering tourist services into a database, said characteristic parameters being entered under the control of a certification body; b) generating tourist paths based on said characteristic parameters; c) transferring said tourist paths to said portable navigation device.

The present invention relates in general to a method and a system for creating tourist paths adapted to be used by a portable navigation device.

More in particular, the present invention relates to a method and a system for creating tourist paths furnished with multimedia contents and reliable, up-to-date information which can be used to advantage by a tourist when visiting a territory.

The increasing need for a high-quality tourist offer, which allows tourists to enjoy all peculiarities offered by different territories, is forcing all parties involved in this field to change their approach to the customer-tourist and to his/her ways of living a holiday.

From the national and international tour operators' point of view, in addition to usable environmental and archeological sites, there is also a need for tourist/accommodation structures which are suitable for tourists who are increasingly demanding in terms of quality/price of the services offered.

Tour operators are discouraged from expanding international tourism, especially during low season periods, by poor organization, lack of accommodation structures (which are only open during high season periods), and by restaurant and hotel managers who often provide poor services at high prices, aiming solely at earning quick money.

From the tourists' point of view, the inexistence of adequate road signs often prevents them from reaching very important sites: of course, this problem is felt even more by foreign tourists whose language has no elements in common with the language spoken in the visited country.

It is certainly true that there are tourist support services, such as associations, clubs and tour operators, that provide useful information and try to establish a trust relationship with the customer. Such a relationship, however, although regulated by a bill of rights, provides no qualitative indication except for the good reputation and history of the structure itself.

Several solutions have been proposed for the purpose of matching the tour operators' needs with the tourist's demands.

For example, United States patent U.S. Pat. No. 7,130,742 describes a content server and a user terminal which can access said content server in order to obtain thematic tourist paths in a city that a tourist wishes to visit. The tourist can examine the selected tourist paths through an Internet site even before setting out on the journey. When the tourist arrives at the region to be visited, the tourist paths are stored into a storage medium adapted to be plugged into a portable navigator. When the tourist actually sets out on the tourist path by using the navigator, he/she can obtain information about the points of interest along that path.

However, when using the navigator according to said U.S. patent, the user receives no guarantee as to the reliability and quality of the information provided. For example, the information provided about a certain restaurant may have been taken from any tourist guide, and perhaps it may still refer to a previous owner, who offered a completely different type of cuisine from the new owner. For a tourist looking for a particular menu or a local specialty, it is very important to obtain accurate, up-to-date and qualitatively correct information. A museum may be taken as a further example, in that opening/closing times often change and tourist guides cannot therefore provide accurate information in this regard.

The object of the present invention is therefore to overcome the above-mentioned drawbacks by providing a method and a system for creating reliable and up-to-date tourist paths adapted to be associated with a portable navigation device.

It is a further object of the present invention to propose a method and a system for creating tourist paths which has high-technology contents and which offers the tourist a certified guarantee that he/she will spend his/her holiday by living the actual reality of the visited region.

These and other objects of the invention are achieved by the portable navigation device, the method and the system as claimed in the appended claims, which are intended as an integral part of the present description.

According to the present invention, a certification body is established which, by integrating and enriching compulsory requirements set out by different tourist certification institutes, can be helpful to a tourist who is exclusively looking for local naturality and authenticity as soon as he/she arrives at the region.

By involving all parties involved in the local tourism chain, said body generates a series of certified paths according to the multi-option holiday principle. Their target being demanding and selective customers, the national and international tour operators, the air carrier and the airport company relying on said body will offer the customer a guarantee that he/she will find high-quality services in that region, the high quality of said services being ensured through severe periodic inspections carried out by said body.

After having defined said tourist paths, together with the local and foreign tour operators, the local authorities and all carriers, according to the distinctive style of the region in terms of reception, tenability and identity, the certification body will be responsible for:

establishing quality requirements for every single path: apart from the quality of restaurants and hotels, such requirements will also define an actual guarantee that a product is compliant with the characteristics of each path. The quality of every element of the tourism chain will be kept under control; in addition to gastronomy, enology and artisanship, attention will also be paid to services to local operators, health and care paths, museums, and methods and times for reaching areas of interest;

analyzing the territory for creating tourist paths: according to a quality and offer coherence logic focused on emotional aspects and territorial identity, those structures will be chosen which will be deemed to be most suitable for a particular tourist path. Adequate support will be given to these structures for the propagation of quality competences needed for territory development and re-qualification, combined with promotion activities within the frame of the already defined integrated tourist offer;

providing new professionalism according to a distinctive style of hospitality, production and management: when a tourist “goes local” in order to gain a better knowledge of the spirit of the territory, he/she will not always find an adequate response outside the normal, unoriginal tourist circuits. For this reason, a common and characteristic distinctive style will be spread throughout the available hospitality services by improving the operators' professional skills, especially in those realities which are not yet accustomed to foreign customers or particular needs;

coordinating the team of quality certifiers and inspectors: after having chosen the points of interest of each path that have accepted to observe the quality protocol, a team of inspectors will be formed which may also include existing tourism quality control authorities; this team of inspectors will periodically verify that the managers of the points of interest keep observing the disciplinary regulations;

creating new ways of spending a holiday without speaking the local language: there is an increasing need of providing tourists who do not speak the local language with a tool that allows them to spend a memorable holiday in any case. To this end, a software information system is created within the structure of the certification body which is compatible with all the most widespread satellite navigators and personal digital assistants, as well as with the main reference cartography. This tool does not only include a simple list of names and addresses, but contains multilingual text and voice providing navigation instructions, detailed descriptions of places of interest (correct opening times, on-line reservation, presence of tourist guides, etc.), recommendations about certified restaurants, with up-to-date menu information, and about certified pensions, hotels, and handicraft production centres.

The above objects will become apparent from the detailed description of the method and system according to the invention, with particular reference to the annexed figures, wherein:

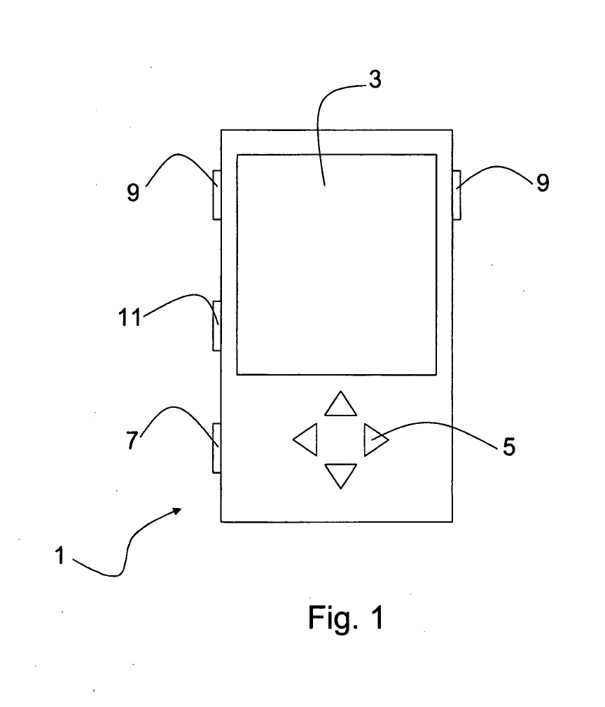

FIG. 1 shows a portable navigation device belonging to the system according to the invention;

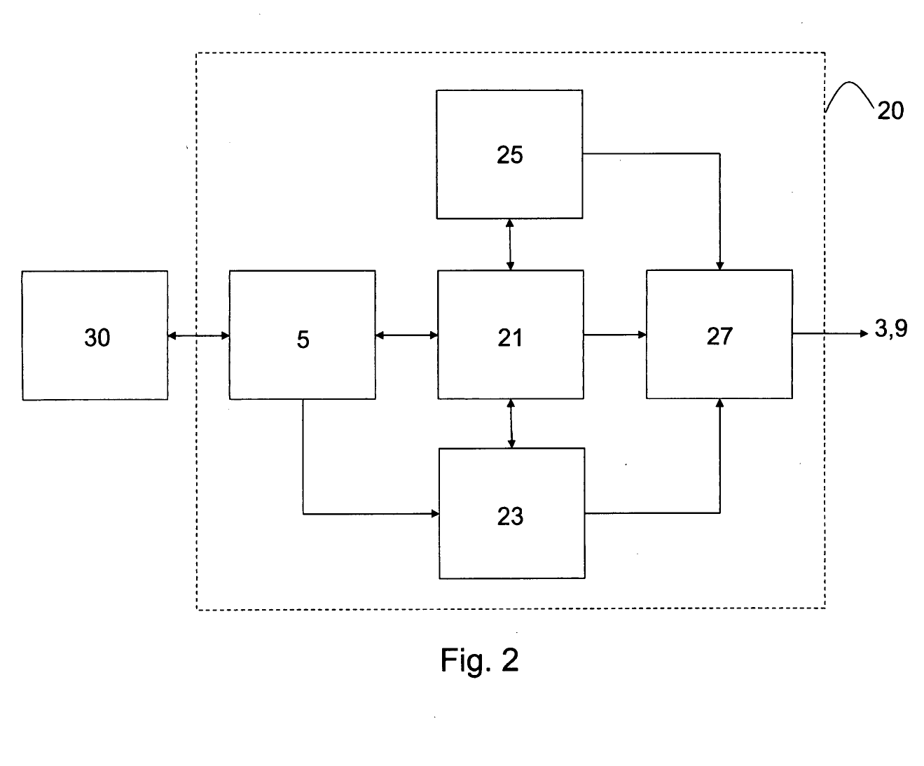

FIG. 2 shows an architecture of the portable navigation device of FIG. 1;

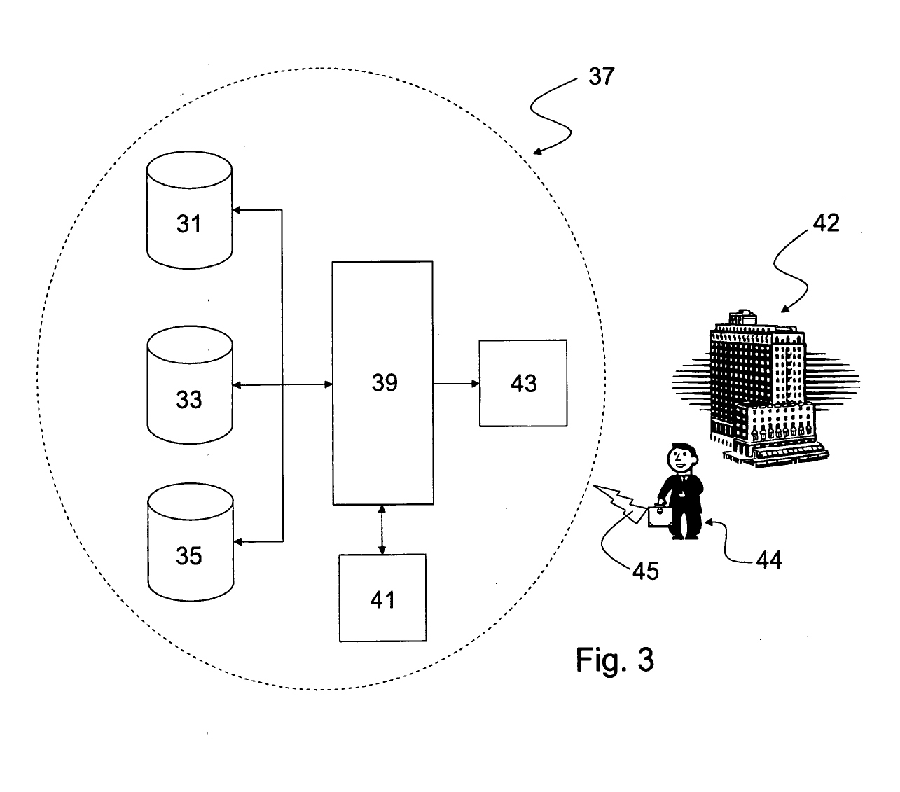

FIG. 3 shows an information technology structure of a certification body of the system according to the invention;

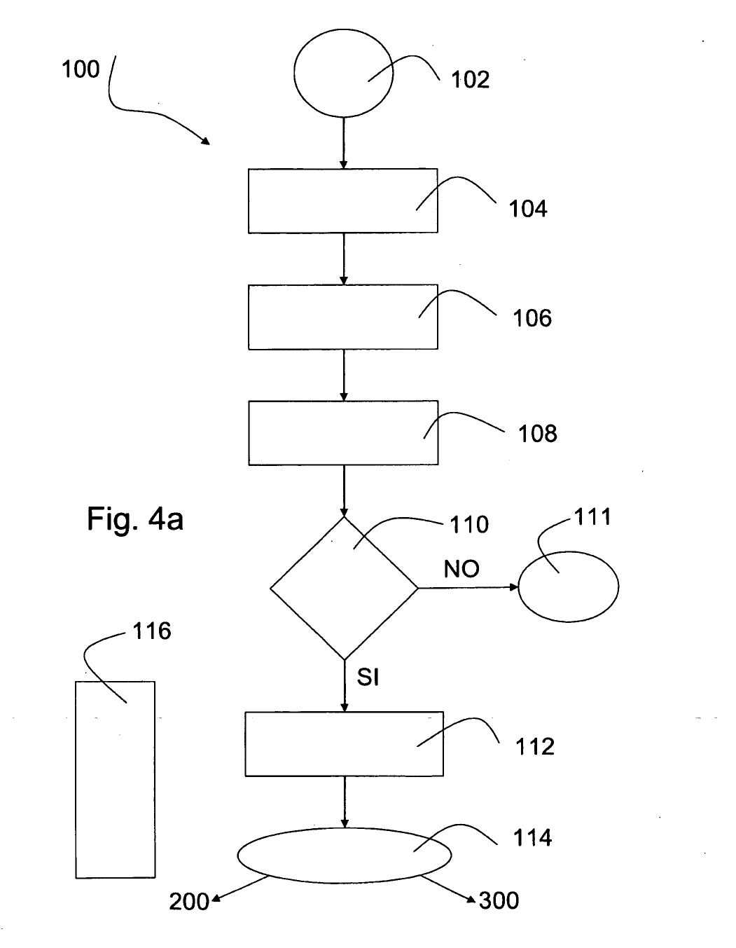

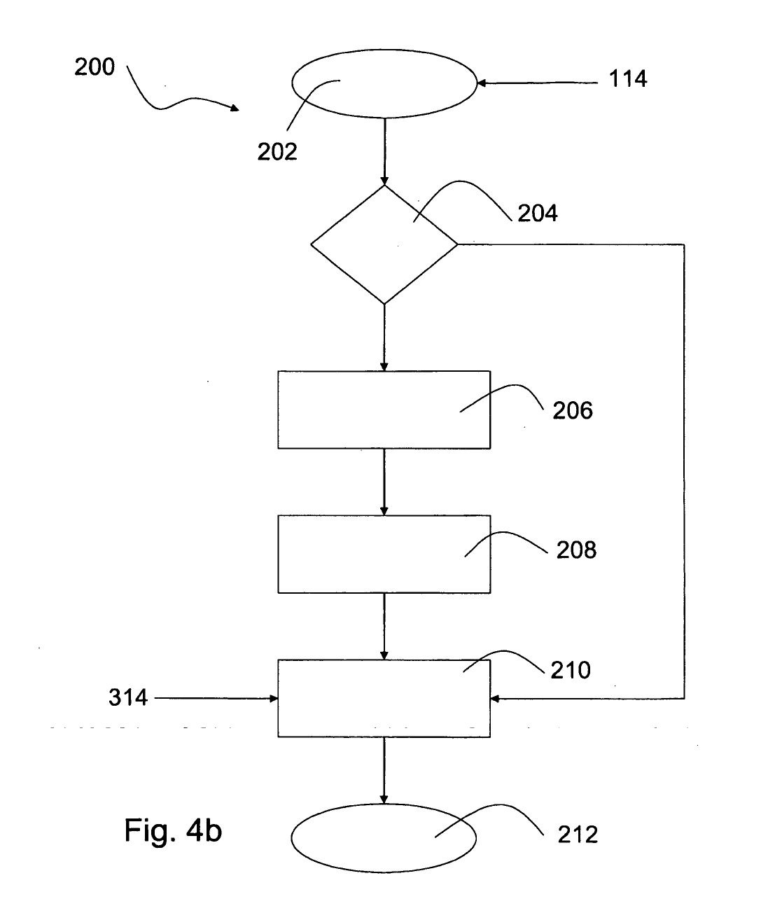

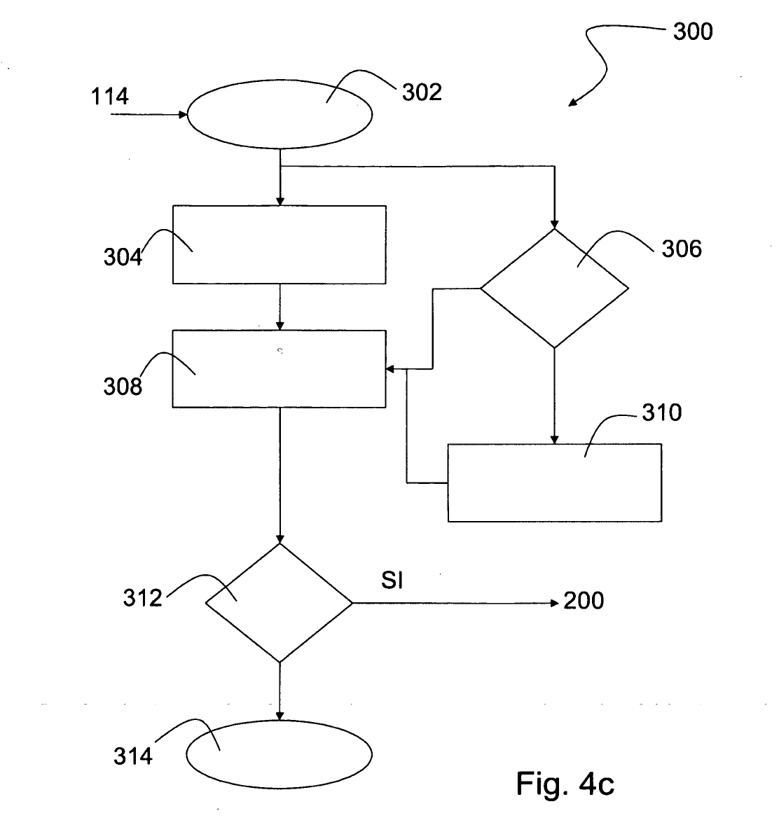

FIGS. 4a-4c are partial flow charts of a method for creating certified tourist paths according to the invention.

Referring now to FIG. 1, it shows a portable navigation device 1 of the system according to the invention.

Portable navigation device 1 looks like a traditional satellite navigator or personal digital assistant, and comprises at least the following:

video reproduction means 3, in particular a display;

selection means 5, consisting in particular of four keys indicating at four different directions: up, down, right, left. Selection means 5 may possibly be supplemented by a keyboard (not shown), or consist of a display 3 of the ‘touch screen’ type, in which case the aforementioned four keys will become unnecessary;

one or more communication ports 7, among which an infrared port, a wireless port, a USB port, a network port and a serial port;

audio reproduction means 9, such as speakers and/or jacks for connecting device 1 to a headset and/or a microphone;

a port 11 for plugging in a storage medium 30, e.g. ‘mini SD’ type.

Referring now to FIG. 2, reference numeral 20 designates the architecture of portable navigation device 1, which comprises at least the following:

a microprocessor 21, acting as a controller of the various functions of device 1;

a memory 23, connected at least to microprocessor 21 and adapted to store at least one tourist path and the associated multimedia contents;

a module for finding position 25 of device 1, e.g. a GPS satellite receiver, connected at least to microprocessor 21 and capable of determining the spatial position of device 1 and, consequently, of the user thereof;

a data integrator module 27, which can process the information received from memory 23 of device 21 and the information received from positioning module 25 in order to reproduce the outcome of said information processing on video reproduction means 3 and on audio reproduction means 9 of device 1.

In a preferred embodiment of the invention, the tourist paths are stored in a memory medium 30, e.g. ‘mini SD’ type, which can be plugged into port 11 of device 1. Memory medium 30 is recognized and managed by microprocessor 21.

Alternatively, the tourist paths are stored directly in memory 23 and are downloaded and/or updated through a communication network, e.g. the Internet, through one of communication ports 7. In any case, path selection takes place through selection means 5.

Referring now to FIG. 3, it shows an information technology structure managed by a certification body 37. Said information technology structure comprises three different databases 31,33,35 and one computer 39.

A first database 31 contains cartographic maps, a second database 33 contains characteristic parameters of certified structures 42, and a third database 35 contains multimedia contents, i.e. text and/or audio and/or video information pertaining to certified structures 42 and/or point of interests located along or near certified tourist paths. The information contained in third database 35 is preferably available in a plurality of languages, so that is can also be used by foreign tourists.

The term ‘certified tourist path’ refers to a tourist path comprising structures which have been certified by certification body 37, i.e. a body that ensures that certified structures 42 observe precise disciplinary regulations set out by certification body 37 itself. In general terms, a certified structure 42 is a structure which can offer services of any kind to a tourist. By way of non-limiting example, the following structures may be certified by certification body 37, thus becoming certified structures 42: hotels, restaurants, farm holidays, bed & breakfasts, hostels, campings, gas stations, drugstores, supermarkets, museums, public parks, and so on.

The characteristic parameters are sent to computer 39 of certification body 37 by special certifiers 44, who are inspectors entitled to evaluate the following:

if a certain structure meets the certification requirements, or

if a certain certified structure 42 is compliant with the disciplinary regulations set out by certification body 37, or

if there have been any variations in the characteristic parameters of certified structure 42.

A characteristic parameter is a parameter that expresses a certain feature of a certified structure. Some examples of characteristic parameters are: the category of a hotel or restaurant, the opening/closing times of a museum, the type of menu offered by a restaurant, etc.

The characteristic parameters can be updated on a daily basis by entrusted certifiers 44, who can send data 45 to computer 39 of certification body 37, as well as by certified structures 42 themselves, which can send any variations occurred in their characteristic parameters to computer 39 of certification body 37 through an authenticated login procedure, e.g. requiring a username and a password.

Computer 39 also uses a path preparation module 41 which can generate certified tourist paths based on directions received from certification body 37. In an Italian region like Sardinia, path preparation module 41 may generate, by referring to the data contained in databases 31,33,35, thematic paths for ancient monuments, churches and museums, or enogastronomic paths for wine, oil, carasau bread, culurgiones, etc. Other types of paths may be based on the maximum time available to the tourist for visiting the region: for example, a one-day visit to the most important monuments of Cagliari, or a three-day visit to the most suggestive Sardinia shores, and so on. Other types of paths may be based on the maximum amount of money that the tourist is willing to spend: for example, a three-day enogastronomic path requiring an expenditure not exceeding a predetermined amount.

It is clear that there are no limits to the creation of certified thematic tourist paths: the larger the number of characteristic parameters in database 33, the more diversified can the tourist path offer be.

The certified tourist paths generated by module 41, together with other certified tourist paths entered at will by certification body 37, are stored in a path memory 43.

Said path memory 43 may be a memory of computer 39 which can be downloaded from the Internet to navigation devices 1 available in various rental points, such as airports, train stations, tourist information offices and the like.

As an alternative, the data stored in path memory 43 can be copied to a memory medium 30, e.g. ‘mini SD’ type, which can be plugged into device 1 through port 11 of device 1. Memory medium 30 may be left to the tourist as a souvenir after he/she has returned device 1 to the rental point, or may be purchased at a newsstand, a tobacconist, a supermarket, a gas station or any other point of sale. In this latter situation, the seller of memory medium 30 is preferably equipped with a computer having access to the computer 39 of certification body 37, e.g. through the Internet, for downloading the latest version of the certified tourist paths before selling memory medium 30 to the customer. If the user buys memory medium 30 without hiring device 1, he/she will necessarily have to own a device which can read the memory medium and the certified tourist paths contained therein.

Referring now to FIGS. 4a-4c, the following will describe a flow chart of the activities that a certification body 37 must carry out in order to implement a certified tourist path service.

With reference to FIG. 4a, flow chart 100 relates to a procedure for generating a bill of services and quality, in particular to the creation of a tourist quality brand.

With reference to FIG. 4b, flow chart 200 relates to the management of first cartographic database 31 and of the user interface of navigation device 1, as well as to the integration of the multimedia contents of database 35 of navigation device 1.

With reference to FIG. 4c, flow chart 300 relates to a procedure for internationalizing the multimedia contents of database 35.

With reference to FIG. 4a, the following will describe in detail the workflow of a procedure for generating a bill of services and quality, in particular for the creation of a tourist quality brand.

Step 102 evaluates the interest of tour operators, airport companies and cruise companies in joining a system for the creation of certified tourist paths according to the invention.

At step 104, a bill of services (or disciplinary regulations) is written which states the tourist quality requirements to be complied with by structures 42 in order to be certified.

At step 106, certified tourist paths are chosen either arbitrarily by certification body 37 or by using path preparation module 41.

At step 108, certifiers 44 make a survey in order to verify the interest of tourist businesses and infrastructures in participating to the system according to the invention.

At step 110, the tourist business or infrastructure decides whether it is willing or not to become a certified structure 42. If not (step 111), the certified structure will not be entered into the certified tourist paths, and no data pertaining thereto will be entered into databases 33 and 35.

In the affirmative case (step 112), certifiers 44 will visit the structure and gather all the characteristic parameters thereof.

Once it has been certified (step 114), structure 42 ratifies the bill of services, and its characteristic parameters and any multimedia contents are entered into database 33 for creating the tourist path.

Once the structure has been certified (step 114), quality inspections may be set up (step 116) which may possibly lead to the ratification of a new bill of services and/or to changes in the characteristic parameters of the certified structure (step 114).

From step 114, the workflow proceeds to flow charts 200 and/or 300.

With reference to FIG. 4b, the following will describe in detail the workflow for the formal creation of a tourist path (step 202).

If the path is included in the original cartography, the flow chart will jump to step 210, which will be described later on.

If the path is not included in the original cartography (step 204), then the original database will be updated through appropriate on-site surveys and possibly also through GPS positioning and cartographic digitalization (step 206).

Step 208 generates an adequate Digital Support System (DSS) which, when integrated into the navigator, will allow the tourist, through a multiple-key questionnaire, to get complete information about the path which will be closest to his/her needs.

At step 210, a digital path is created by entering the multimedia contents generated through the steps of the flow chart shown in FIG. 4c, which will be described later on.

An actual tourist path is thus created at step 212.

With reference to flow chart 300 of FIG. 4c, the following will describe in detail the procedure for internationalizing the multimedia contents.

At step 302, text documents are received from the path members and/or any characteristic parameter changes are communicated by certifiers 44.

At step 304, the multimedia contents are translated into a plurality of languages.

At step 308, the multimedia contents are connected to cartographic database 31, to the navigation software of navigation device 1 and to the DSS system.

Step 304 is carried out in parallel to step 306, wherein it is verified if the multimedia contents for certified structure 42 included in the path are already present in the database. If they are, the flow chart will go to the aforementioned step 308; if they are not, multimedia contents including video and audio guides will be created at step 310.

At step 312, it is verified if it is already necessary to make any changes to the user interface and/or to the DSS system. If yes, the aforementioned procedure described in flow chart 200 will be started; if not, internationalization procedure 300 will end, and every certified path will contain all the necessary information translated into a plurality of languages, complete with audio and video guides.

The features of the present invention, as well as its advantages, are apparent from the above description.

By creating certified tourist paths which are not evaluated as they are, but are created ex novo by binding every certified structure to observe precise disciplinary regulations, it is possible to accurately meet a tourist's needs, such as: accuracy of destinations, authenticity and naturality, linguistic support, usability of accommodation services, more available time, possibility of exclusive emotions, autonomous organization, buying unique high-quality products.

The simple interface of portable navigation device 1 allows for quick and intuitive use, thus providing helpful support and synergic guidance without requiring any particular ability or technical skill.

Creating certified tourist paths involves a high level of cartographic detail for showing the certified structures, thus requiring descriptions of country and mountain roads as well.

A certified tourist path is therefore characterized by certainty, accuracy and reliability of the available services: this means good organization and quickness in meeting the customer's needs, leading to a good service/price ratio in a polite environment.

Thanks to multimedia contents provided in a plurality of languages, this system also takes into account the needs of a tourist whose language has no roots in common with the language spoken in the visited region.

The method and system for creating tourist paths adapted to be used by a portable navigation device described herein by way of example may be subject to many possible variations without departing from the novelty spirit of the inventive idea; it is also clear that in the practical implementation of the invention the illustrated details may have different shapes or be replaced with other technically equivalent elements.

It can therefore be easily understood that the present invention is not limited to the above-described method and system for creating tourist paths adapted to be used by a portable navigation device, but may be subject to many modifications, improvements or replacements of equivalent parts and elements without departing from the novelty spirit of the inventive idea, as clearly specified in the following claims.

1. Method for creating tourist paths adapted to be used by a portable navigation device (1), said method comprising the steps of:
a) entering characteristic parameters of at least one structure (42) capable of offering tourist services into a database (33), said characteristic parameters being entered under the control of a certification body (37);
b) generating tourist paths based on said characteristic parameters;
c) transferring said tourist paths to said portable navigation device (1).

2. Method according to claim 1, characterized in that said step a) is preceded by a step wherein said characteristic parameters are sent by said at least one structure (42), through an authenticated login procedure, to a computer (39) associated with said database (33).

3. Method according to claim 1, characterized in that said step a) is preceded by a step wherein said characteristic parameters are sent by a certifier (44).

4. Method according to one or more of the preceding claims, characterized by comprising a further step of entering cartographic maps into a second database (31) and multimedia contents relating to said at least one structure (42) into a third database (35), said second (31) and third (35) databases being accessible to said computer (39).

5. Method according to claim 4, characterized in that said step b) comprises a step of generating said tourist paths based on predefined themes by retrieving and processing data from said first (33) and/or second (31) and/or third (35) databases.

6. Method according to claim 4 or 5, characterized in that said step b) comprises a step of generating said tourist paths based on predefined time constraints by retrieving and processing data from said first (33) and/or second (31) and/or third (35) databases.

7. Method according to one or more of the preceding claims, characterized in that said step c) comprises the step of transferring said tourist paths to a memory medium (30) adapted to cooperate with said portable navigation device.

8. Method according to one of claims 1 to 6, characterized in that said step c) comprises the step of transferring said tourist paths to said portable navigation device (1) through a communication networks, in particular the Internet.

9. Method according to one or more of the preceding claims, characterized by comprising a further step of selecting at least one of said tourist paths through selection means (5) of said portable navigation device (1).

10. Method according to the preceding claim, characterized by comprising a further step of displaying said selected tourist path on visualization means (3) of said portable navigation device (1).

11. Method according to the preceding claim, characterized by comprising a further step of playing multimedia contents associated with said selected tourist path on said portable navigation device.

12. Method according to claim 10 or 11, characterized by comprising a further step of finding the spatial position of said portable navigation device (1) and displaying points of interest associated with said position on said portable navigation device.

13. Method according to one or more of claims 5 to 12, characterized in that said tourist path is selected on said portable navigation device (1) through a multiple-key questionnaire.

14. Method according to one or more of the preceding claims, characterized in that said certified structures may include: hotels, pensions, campings, farm holidays, hostels, bed & breakfasts, restaurants, trattorias, wine shops, shops, parks, museums, archeological sites.

15. System for creating tourist paths, comprising:
a computer (39) associated with at least one database (33) in which characteristic parameters of at least one structure (42) capable of offering tourist services can be entered, said characteristic parameters being entered under the control of a certification body (37);
means (41) for generating tourist paths based on said characteristic parameters;
a portable navigation device (1), and
means (30) for transferring said tourist paths to said portable navigation device (1).

16. System according to claim 15, characterized in that said computer (39) is also associated with a second (31) and a third (35) databases, said databases (31,35) containing cartographic maps and multimedia contents relating to said at least one structure (42), respectively.

17. System according to claim 15 or 16, characterized in that said computer (39) is associated with a path preparation module (41), said module retrieving and processing data from said first (33) and/or second (31) and/or third (35) databases.

18. System according to one or more of claims 15 to 17, characterized in that said means (30) for transferring said tourist paths to said portable navigation device (1) consist of a memory medium, in particular ‘mini-SD’ type, adapted to cooperate with said portable navigation device (1).

19. System according to claim 18, characterized in that said portable navigation device (1) comprises a port (11) suitable for housing said memory medium (30).

20. System according to any of claims 15 to 17, characterized in that said means (30) for transferring said tourist paths to said portable navigation device (1) consist of a communication network, in particular the Internet.

21. System according to one or more of claims 15 to 20, characterized in that said portable navigation device (1) comprises selection means (5) for selecting at least one of said tourist paths.

22. System according to claim 21, characterized in that said portable navigation device (1) comprises video reproduction means (3) and audio reproduction means (9) for playing multimedia contents relating to said at least one tourist path.

23. System according to one or more of claims 15 to 22, characterized in that said portable navigation device (1) comprises one or more communication ports (7) chosen among a group including at least the following ports: an infrared port, a wireless port, a USB port, a network port and a serial port.

24. System according to one or more of claims 15 to 23, characterized in that said portable navigation device (1) comprises a satellite positioning module (25), in particular GPS type, for finding the spatial position of said device (1).

25. System according to claims 22 and 24, characterized in that said portable navigation device (1) comprises an integrator module (27) for integrating the data supplied by said satellite positioning module (25) with the data of said tourist path stored in a memory (23) of said device (1), the outcome of said integration being supplied to said video reproduction means (3) and audio reproduction means (9) of said device (1) for audio/video reproduction.

26. System according to claim 25, characterized in that said at least one selected tourist path is extracted from said memory (23) in accordance with the answers provided by the user to a multiple-key questionnaire generated by said device (1).

27. Memory medium (30) adapted to be used in a portable navigation device (1), characterized in that tourist paths are stored in said medium (30) in accordance with any of claims 1 to 14.

28. Method, system, portable navigation device (1) and memory medium (30) adapted to cooperate with said portable navigation device (I) according to the innovative teachings of the present description and of the annexed drawings, which represent preferred and advantageous examples of embodiment of said system.
